(19) United States
(12) Patent Application Publication
(10) Pub. No.: US 2011/0191395 A1
(43) Pub. Date: Aug. 4, 2011

(54) Reducing Image Footprints

(76) Inventors: Pradeep TUMATI, Fremont, CA (US); David REYNA, San Francisco, CA (US); Dave LERNER, Northbrook, IL (US)

(21) Appl. No.: 12/696,518

(22) Filed: Jan. 29, 2010

(51) Int. Cl. G06F 17/30

(52) U.S. Cl. 707/822; 707/E17.01

(57) ABSTRACT

Systems, devices and methods for receiving first data related to a file system of a platform on a target device, receiving second data related to the file system, analyzing the first and second data to determine a necessity level for files of the file system and generating a report indicating the necessity level of the files to reduce a size of the file system of a platform project.

### BACKGROUND

A computing platform generally includes a software framework including application frameworks in which software is enabled to run. Embedded computing platforms, for example, cell phones, GPS systems, routers, etc. have limited hardware resources such as memory, secondary storage space, etc. Thus, embedded systems cannot cope up with code intensive desktop software frameworks. Such restricted resource computing platforms need trimmed down or minimized/optimized software frameworks that contain only the absolutely essential functionalities/files. It is therefore imperative to optimize software frameworks such that embedded systems with limited hardware resources can execute them without any performance degradation. Footprint minimization is a technique by which software frameworks can be specifically optimized for embedded systems that have limited hardware resources.

Prior to deployment of a platform project, developers attempt to optimize the platform. As part of the optimization, developers strive to trim down the footprint (or the size) of the file system image of the respective platform project. In a particular application of minimizing the footprint of a file system image, an optimization and/or minimizing a file system includes eliminating unnecessary files. For example, a file system image can contain different kinds of files such as executables (binary and scripts), device files, shared libraries, config files, data files, etc. When optimizing the file system image, some files associated with the platform are not anticipated to be used and thus, the unnecessary files are stripped out of the file system image. Another way to trim down the size of a file system image is to eliminate unwanted daemons and their associated configuration files from the file system image and thus, the platform project is modified to ensure the daemons do not start in the first place. Additional files to which the unwanted daemons depend upon are also eliminated. These unwanted files otherwise occupy space in the file system that decrease the efficiency of the target embedded platform.

### SUMMARY OF THE INVENTION

A system having a memory storing a set of instructions executable by a processor, the instructions being operable to receive first data related to a file system of a platform on a target device, receive second data related to the file system, analyze the first and second data to determine a necessity level for files of the file system and generate a report indicating the necessity level of the files to reduce a size of the file system of a platform project.

A system having a host device receiving first data related to a file system of a platform on a target device and generating second data related to the file system, the host device analyzing the first and second data to determine a necessity level for files of the file system and generate a report indicating the necessity level of the files to reduce a size of the file system of a platform project.

A device having a first receiving means for receiving first data related to a file system of a platform on a target device, a second receiving means for receiving second data related to the file system, an analyzing means for analyzing the first and second databa to determine a necessity level for files of the file system and a generating means for generating a report indicating the necessity level of the files to reduce a size of the file system of a platform project.

### DESCRIPTION OF THE DRAWINGS

FIG. 1 shows a utility for providing information to reduce an image footprint according to an exemplary embodiment.

FIG. 2 shows a method for reducing an image footprint according to an exemplary embodiment.

### DETAILED DESCRIPTION

The exemplary embodiments may be further understood with reference to the following description and the appended drawings, wherein like elements are referred to with the same reference numerals. The exemplary embodiments describe a utility for reducing a footprint (or size) of a file system image. Specifically, the utility assists users in examining a file system image to determine a necessity of each file and delete unnecessary files, thereby reducing the size of the file system. The utility, the file system image, a necessity level of files, and an associated method will be discussed in further detail below.

The utility may be implemented as a command line utility or as an eclipse/workbench plug-in. A command line implementation may provide plain data to a user. A workbench implementation may also provide various inputs that generate customizable visual reports. The workbench plug-in may be combined with further workbench plug-ins (e.g., system viewer) that may receive outputs from the utility and provide enhanced workflows that further assist the user in minimizing and/or optimizing the file system. Those skilled in the art will understand that the workbench terminology is related to products distributed by Wind River Systems, Inc. of Alameda, Calif. In a more generic terminology, the output of the utility may be visualized using GUI applications.

The following provides several examples of functionality that may be included within the exemplary utility to aid the developer in reducing the footprint of the platform project. Those skilled in the art will understand that the following examples are not exhaustive and also that the exemplary utility is not required to implement every functionality. In a first example, a touch analysis may be performed. The touch analysis may entail specifying a time period in which a file was “touched” (i.e., accessed, opened, referred, etc.). A list of the touched files may allow users to identify files that were accessed and/or modified during the given time interval. For example, users may want a list of files that were touched during a boot time frame. This list may help customers in analyzing file input/output operations during the boot process and identify all files that are not necessary for booting. The exemplary embodiments may be configured to perform this operation.

In a second example, a shared library analysis may be performed. A platform project may potentially include hundreds of shared libraries. In order to eliminate unnecessary shared libraries, a user may examine which executables require a particular shared library. The exemplary embodiments may be configured to perform this operation by inputting the name of a shared library and returning a list of executable files that depend upon that library. The exemplary embodiments may further parse the file system and generate a list of libraries that none of the executables depend thereupon.

In a third example, review reports that assist users in understanding a file system may be generated by the utility. For example, the report may list types of files that reside in the file system image. The report may show a number of the largest files, files greater than a predetermined size, a list of executable files, etc. The user may extract relevant information from these reports to better minimize a file system image. The exemplary embodiments may be configured to generate the reports.

In a fourth example, the exemplary utility may take a runtime snap shot. Users may view an instant snap shot of all executing processes, memory usage, open file handles, etc. In a similar manner as the reports except on an instant level, the snap shot may assist in strategizing ways to optimize a file system image. The exemplary embodiments may be configured to generate the snap shot.

In a fifth example, the exemplary utility may implement a viewable runtime monitor. Similar to the touch analysis, the runtime monitor may specifically list executables that were executed in a defined time interval. Users may extract pertinent information from the runtime monitor to determine which executables are necessary. The exemplary embodiments may be configured to perform this operation.

In a sixth example, the exemplary utility may display executable dependencies. Executable files resident on a target may depend on a number of files that reside on the target as well. These files may include, for example, config files, data files, shared library files, etc. Users may view a list of dependent files and determine a means to eliminate some of the unwanted files. The exemplary embodiments may be configured to perform this operation.

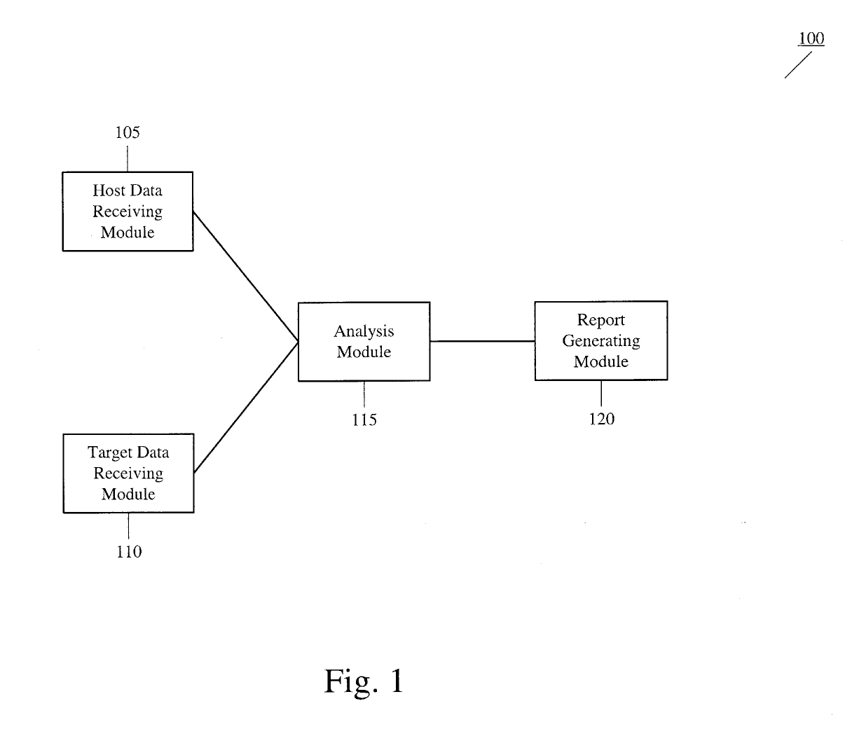

FIG. 1 shows a utility 100 for providing information to reduce an image footprint according to an exemplary embodiment. The utility 100 may gather data related to a platform to be analyzed in order to generate a report. The information on the report may subsequently be used as a basis to reduce the footprint of the file system image. The utility 100 may include a host data receiving module 105, a target data receiving module 110, an analysis module 115, and a report generating module 120.

The utility 100 according to the exemplary embodiments may relate to a file system where information pertinent to identify unnecessary files may be acquired from either a host or a target. For example, data regarding the files and shared library dependencies may be obtained from either the target or the host. In another example, snapshot and touch data may be captured from the target by only the target. The utility 100 may be configured so that capturing and processing of the host and target received data may be performed on the host to reduce resource usage and increase overall efficiency. However, such processing at the host is not a requirement of the exemplary embodiments.

The host data receiving module 105 may receive predetermined types of data relating to the platform of the target. In particular, the host data receiving module 105 may parse an export directory and perform a variety of operations. In a first exemplary operation, the host data receiving module 105 may parse a file system image and classify each file into a type of category. The types may include, for example, executable elf files, executable script files, config files, device files, shared libraries, data files, etc. In a second exemplary operation, the host data receiving module 105 may capture file attributes. The file attributes may include, for example, absolute file path, file size, dependent shared files, dependent config files, dependent data files, etc. Upon performing these exemplary operations, the data may be stored for further analysis. The data may be stored in, for example, a memory of the host, a relational database, a database of a network, etc.

In one exemplary embodiment, as the data is captured it is stored in data structures. Each file is stored as a node and each node may contain fields for the file attributes as determined by the above second operation. It should be noted that there may be other manners of storing the data and generating comprehensive data for the project and the above manner is only exemplary. In addition, while not specifically described below with respect to data generated by the target device, these same manners may be used for such data.

As discussed above, the comprehensive database may include information about all the files that the host data receiving module 105 finds in the target file system. Thus, when a query is entered into a user interface for the host data receiving module 105, the predefined parameters of the query may be a basis to search the host for the host data.

The target data receiving module 110 may receive other data that may not have been gathered by the host data receiving module 105 or data that may only be gathered on the target side. That is, the target data receiving module 110 may receive data from a variety of sources such as a target file system, a proc directory, system tap, target profiler, a further third party source, etc. The target data receiving module 110 may provide command line arguments to capture runtime information from these sources to generate a snapshot database.

The target data receiving module 110 may generate the snapshot database by capturing target runtime information to generate a binary file embodied in the snapshot database. The snapshot database may be copied over to the host. As discussed above, when analyses are performed on the host, a lower resource usage may be realized on the target end. A query may also be entered into the user interface to select appropriate parameters to be searched within the snapshot database.

Regarding the target file system, the target data receiving module 110 may parse all directories on the target to identify files that were touched between a predetermined time interval. Furthermore, a time at which the files were accessed and modified may be recorded. Regarding the proc directory, the target data receiving module 110 may parse the proc file system to capture the instant snap shot of the system by acquiring specific types of data. For example, the data may include a list of running processes, file paths of executable files, a list of open file handles, a list of open shared libraries, a memory usage, etc. This data may provide information relating to file dependencies of processes are being executed. Regarding the system viewer, the target data receiving module 110 may acquire runtime information of the target. For example, a list of processes that were executed during a given time interval may be included.

The analysis module 115 may receive the data from the host data receiving module 105 and the target data receiving module 110. The analysis module 115 may analyze the data and generate results relating to assisting a minimization of a footprint of a file system image.

The analysis module 115 may be configured to process the comprehensive database generated by the host data receiving module 105, generate file dependencies and optionally integrate the target data generated by the target data receiving module 110. For example, executable-shared library dependencies may be determined by examining an executable's dynamic sections. In another example, if an executable file opens a config, data, device, or shared library file, an elf string table may include a respective name. The analysis module 115 may use appropriate regular expressions, parse a string table, and identify the files the executable program opens. The touch file information generated by the target data receiving module 110 can be integrated with the file dependencies.

The report generating module 120 may receive the results from the analysis module 115 including the comprehensive database and the snapshot database to generate appropriate reports requested by a user. The report generating module 120 may be configured to generate different types of reports. For example, a simple text file list may be generated; a tab-delimited file list may be generated; a touch-file update list and/or additions list may be generated; a touch-file replacement list may be generated; etc. The reports may include the information relating to the analyses discussed above. For example, the reports may include a list of files touched between a predetermined time period, a list of executable files and dependent files thereof, a list of unused shared libraries, a list of all executables that depend upon a particular shared library, a list of files exceeding a predefined size, a list of executables that depend upon a particular data and/or config file, snapshot information, a list of processes that executed between a predetermined time interval, etc.

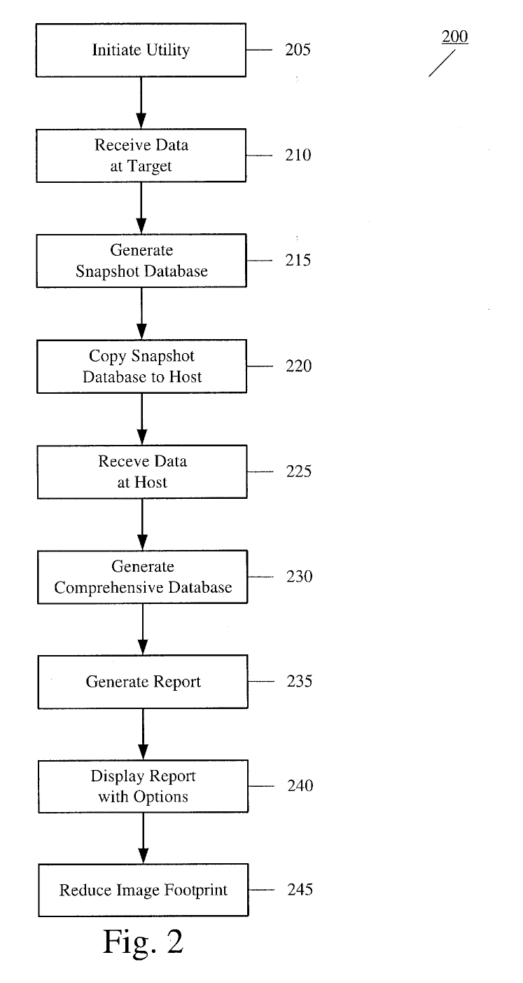

FIG. 2 shows a method 200 for reducing an image footprint according to an exemplary embodiment. The method 200 will be described with reference to the utility 100 of FIG. 1. As will be described in further detail below, the method 200 may be automatic or manual. That is, the utility 100 may perform the reduction of the image footprint automatically when the user initiates the utility 100 or may manually control the process for each step.

In step 205, the utility 100 may be initiated. The utility 100 may be associated with the host. As discussed above, the analysis being performed on the host may reduce resource usage on the target. However, it should be noted that the utility 100 may also be associated with the target if configured to handle the processing necessary for the analysis.

In step 210, data from the target may be received by the target data receiving module 110. As discussed above, the target data may include a variety of types ranging from the touch analysis to the executable dependencies. Once the target data is received in step 210, in step 215, the snapshot database may be generated. According to the exemplary embodiment, these processes may be performed on the target. Those skilled in the art will understand that creating the snapshot database may not require nearly as much resource usage in comparison to an analysis functionality. Since the snapshot database is generated on the target and the host is designated to perform the analysis, in step 220, the snapshot database may be copied to the host. However, it should be noted that the host may be configured to have access to all data on the target so that the snapshot database of the target may be generated remotely on the host, thereby not requiring step 220.

In step 225, further data from the target may be received by the host data receiving module 105. As discussed above, the host data may also include a variety of types ranging from the touch analysis to the executable dependencies. Once the host data is received in step 225, in step 230, the comprehensive database may be generated.

It should be noted that the above steps may be performed automatically or manually. For example, in an automatic process, the user may initiate the utility 100 in which steps 210-220 are performed. The user may subsequently initiate the utility 100 in which steps 225-230 are then performed. In another example, in a manual process, the user may be prompted at each step to verify that the next step is to be performed.

Once the snapshot database and the comprehensive database are generated, the method 200 may continue to step 235 where a report is generated. It is noted that as part of step 235, the user may select the type of report that the user desires. Thus, the system generates a report based on the input of the user. The report may be a result of the databases being analyzed by the analysis module 115. As discussed above, the analysis module 115 may perform a variety of functions to determine a necessity level of the files of the file system for the platform on the target. In step 240, the report may be displayed to a user. Those skilled in the art will understand that the display of the report is limited to those systems that implement a GUI for display, e.g., a CLI implementation would not be able to display the report. Furthermore, the report may include options such as a deletion of a file or removal from a process in which a dependency is detected. The analysis module 115 may be configured to perform this functionality as well.

In step 245, the image footprint of the file system for the platform may be reduced. According to an exemplary embodiment, the user may manually select files for deletion and/or removal based upon the report and/or options from the report. According to another exemplary embodiment, the user may enter parameters into the utility 100 to perform a global reduction of the image footprint based upon the parameters. For example, the user may define predetermined rules such as if file(s) residing in a particular location are not touched during bootup or if a shared library has no executable dependencies, etc., such files may be automatically deleted from the footprint.

According to the exemplary embodiments, an image footprint of a file system for a platform may be reduced in a thorough analysis of the files related thereto. The utility of the exemplary embodiments may perform a variety of analyses necessary to determine a necessity level of files so that a further determination may be made of whether an unnecessary file should be removed. The analyses may include performing a touch analysis, a shared library analysis, a report analysis, a runtime snap shot analysis, a runtime monitor analysis, and an executable dependency analysis. The utility of the exemplary embodiments may combine these different functions to provide a comprehensive analysis of the file system of the platform.

The utility of the exemplary embodiment may be embodied as a template which may be compatible with all platforms. The utility may be stored in a portable storage device that may be connected to a host or target to perform the above processes. The utility may automatically configure itself based upon a detected platform in which the host or target is executing. The utility may also be manually configured to perform the above processes based upon a manually entered platform to be analyzed. Thus, according to an exemplary embodiment, the utility may be a modular device including the modules described with reference to FIG. 1.

Those skilled in the art will understand that the exemplary embodiments described herein may be implemented in any number of manners, including as a separate software module, as a combination of hardware and software, etc. To provide a specific example, the above described analysis module may be embodied as lines of code stored in a memory (computer readable storage medium) that, when compiled, may be executed by a processor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A system comprising a memory storing a set of instructions executable by a processor, the instructions being operable to:
receive first data related to a file system of a platform on a target device;
receive second data related to the file system;
analyze the first and second data to determine a necessity level for files of the file system; and
generate a report indicating the necessity level of the files to reduce a size of the file system of a platform project.

2. The system of claim 1, wherein the first data is generated by the target device.

3. The system of claim 2, wherein the second data is generated by a host device.

4. The system of claim 3, wherein the analyzing and generating are performed by the host device.

5. The system of claim 3, wherein the instructions are further operable to:
copy the first data from the target device to the host device.

6. The system of claim 1, wherein the first data relates to runtime information of the platform.

7. The system of claim 6, wherein the runtime information relates to a list of running processes at a predetermined time interval, a list of file paths of executable files, a list of open file handles, a list of open shared libraries, and a list of memory usage.

8. The system of claim 1, wherein the second data relates to file dependencies of the platform.

9. The system of claim 8, wherein the file dependencies relate to executable elf files, executable script files, config files, device files, shared libraries, and data files, the file dependencies further relating to absolute file paths, file sizes, dependent shared files, dependent config files, and dependent data files.

10. The system of claim 1, wherein the instructions are further operable to:
determine an option to one of modify and delete the files as a function of the respective necessity level.

11. A system, comprising a host device receiving first data related to a file system of a platform on a target device and generating second data related to the file system, the host device analyzing the first and second data to determine a necessity level for files of the file system and generate a report indicating the necessity level of the files to reduce a size of the file system of a platform project.

12. The system of claim 11, further comprising:
the target device generating the first data related to the file system of the platform on the target device.

13. The system of claim 12, wherein the target device is configured to transmit the first data to the host device.

14. The system of claim 11, wherein the first data relates to runtime information of the platform.

15. The system of claim 14, wherein the runtime information relates to a list of running processes at a predetermined time interval, a list of file paths of executable files, a list of open file handles, a list of open shared libraries, and a list of memory usage.

16. The system of claim 11, wherein the second data relates to file dependencies of the platform.

17. The system of claim 16, wherein the file dependencies relate to executable elf files, executable script files, config files, device files, shared libraries, and data files, the file dependencies further relating to absolute file paths, file sizes, dependent shared files, dependent config files, and dependent data files.

18. The system of claim 11, wherein the host device removes files from the file system based on the first and second data and a set of predetermined rules.

19. The system of claim 11, wherein the second data is captured in a balanced binary tree format.

20. A device comprising:
a first receiving means for receiving first data related to a file system of a platform on a target device;
a second receiving means for receiving second data related to the file system;
an analyzing means for analyzing the first and second databa to determine a necessity level for files of the file system; and
a generating means for generating a report indicating the necessity level of the files to reduce a size of the file system of a platform project.
